(19) United States
(12) Patent Application Publication
(10) Pub. No.: US 2026/0350018 A1
(43) Pub. Date: Nov. 5, 2026

(54) MEMORY AUGMENTATION IN AN IMMERSIVE ENVIRONMENT

(71) Applicant: GOOGLE LLC, Mountain View, CA (US)

(72) Inventors: Juston Payne, Woodside, CA (US); Andrea Colaco, Los Altos, CA (US); Grant Yoshida, Sunnyvale, CA (US); Bhanu Prakash Reddy Guda, Sunnyvale, CA (US); Nishtha Bhatia, Fremont, CA (US); Ran Xin, San Jose, CA (US); Gary Lee Vondran, JR., San Carlos, CA (US); Lin Li, Sunnyvale, CA (US); Renhao Liu, Mountain View, CA (US); Richard William Worsfold, Kirkland, WA (US); Achin Kulshrestha, Toronto (CA); Christopher Max Breithaupt, Berkeley, CA (US); Brandon Im, San Carlos, CA (US)

(21) Appl. No.: 19/668,459

(22) Filed: May 5, 2026

Related U.S. Application Data
(60) Provisional application No. 63/800,208, filed on May 5, 2025.

(51) Int. Cl. G06F 16/2457; G06F 21/62; G06V 20/20; G10L 15/08

(52) U.S. Cl. CPC G06F 16/24575; G06F 21/6245; G06V 20/20; G10L 15/08; G10L 2015/088

(57) ABSTRACT

Methods and systems for providing memory augmentation via a head-wearable device are provided. The head-wearable device captures data from a user's point of view using sensors such as a camera, microphone, or inertial measurement unit. In response to determining that a first portion of the data is associated with the user based on a context of a second portion of the captured data, the first portion is stored in a multi-tiered memory architecture including on-device, mobile device, and cloud-based storage. Data storage and transfer may be managed based on logistical factors such as connection strength and power state to optimize battery life. Upon receiving a query, the system retrieves the stored data and utilizes a model to generate a response. The system may further identify trigger conditions or salient entities to trigger data capture and may implement a privacy-first architecture to ensure privacy is preserved.

### CROSS-REFERENCE TO RELATED APPLICATION

This application claims priority to U.S. Provisional Patent Application No. 63/800,208, filed on May 5, 2025, entitled “Memory Augmentation in an Immersive Environment”, the disclosure of which is incorporated by reference herein in its entirety.

### BACKGROUND

People are exposed to a large amount of information in their day-to-day lives. With the large amount of information available and the numerous tasks people perform every day, it is often challenging to remember certain details about the environments people encounter, such as where certain objects are located in the environment.

### SUMMARY

Systems and techniques are described for providing memory augmentation as people go about their days while using a wearable device, such as a device providing an extended reality. A wearable device, such as smart glasses, may include several sensors that can capture various types of data. The sensors may include cameras, microphones, and other types of sensors that capture environmental data. The data captured by the sensors may include visual, audio, and location data and may be stored on the wearable device locally and/or in a remote memory (e.g., another device or cloud-based memory). The stored data can be later retrieved directly for use by a user of the wearable device or can be retrieved for use by another application, such as a conversational agent. For example, a conversational agent may retrieve the stored data in order to respond to a user query.

The details of one or more implementations are set forth in the accompanying drawings and the description below. Other features will be apparent from the description and drawings, and from the claims.

### BRIEF DESCRIPTION OF THE DRAWINGS

FIGS. 1A-1B depict example memory augmentation environments in which a user wears a head-wearable device in a physical environment, and the head-wearable device responds by storing details about the physical environment in a memory, according to an aspect.

FIG. 1C depicts an example memory augmentation environment in which stored memories are retrieved for a user, according to an aspect.

FIG. 2A depicts an example head-wearable device worn by a user, according to an aspect.

FIG. 2B depicts a front view, and FIG. 2C depicts a rear view of the head-wearable device shown in FIG. 2A, according to an aspect.

FIG. 3 is a block diagram of a memory augmentation system, according to an aspect.

FIG. 4 is a block diagram of some elements involved in memory ingestion in a memory augmentation system, according to an aspect.

FIG. 5 is a block diagram of some elements involved in memory retrieval in a memory augmentation system, according to an aspect.

FIG. 6 depicts a flowchart of a method for providing memory augmentation via a wearable device, according to some aspects.

FIG. 7 depicts a flowchart of an alternative method for providing memory augmentation via a wearable device, according to some aspects.

### DETAILED DESCRIPTION

Real world memory augmentation for immersive environments is described herein. People encounter a vast amount of information daily, often exceeding the human brain's capacity to retain specific details such as the location of misplaced belongings or the names of places and objects seen in passing. Existing digital solutions typically require active user intervention, such as manual notetaking or photographing objects, which creates friction and often leads to fragmented information that is difficult to retrieve. The implementations disclosed herein address these challenges by providing an ambient, multi-sensory system integrated into a head-wearable device that passively and actively captures data from a user’s point of view. By utilizing low-power sensors to identify trigger conditions and salient entities, the system efficiently filters and stores relevant environmental context, such as visual, audio, and location data, in a structured memory bank. These stored memories are then made accessible through an AI-driven conversational agent, allowing users to perform ad hoc or ubiquitous queries to recall specific details from their daily lives seamlessly. This approach effectively provides users with a reliable photographic memory while optimizing for device battery life and user privacy.

In the modern digital era, individuals are immersed in a near-limitless stream of information as they navigate their daily lives. On any given day, a person may encounter dozens of locations, hundreds of objects, and a continuous flow of visual and auditory stimuli. Despite the vast amount of data available, the human brain possesses a finite capacity for retention, often leading to the frustration of misplaced belongings, forgotten names of places visited in passing, or the loss of specific details from a conversation or a document read earlier in the day. As extended reality (XR) environments and head-wearable devices become more integrated into daily routines, users increasingly rely on these systems to facilitate interactions with conversational agents or other applications to manage tasks and retrieve information. While such environments offer the potential to bridge the gap between human memory and digital data, the challenge of efficiently capturing, organizing, and retrieving relevant personal information remains a significant technical problem.

At least one technical problem addressed by the present implementations relates to the massive memory and power requirements associated with maintaining a comprehensive digital record of a user's life. Conventional attempts to provide a form of photographic memory often rely on continuous data logging, which creates a technical problem of excessive storage consumption and rapid battery depletion on mobile or wearable computing devices. To enable ad hoc retrieval of a memory that may have occurred at any point in the past, a system must theoretically store a massive volume of high-resolution data. However, continuously scanning for, capturing, and storing every sensory input in an environment leads to severe technical problems with memory management and power usage, rendering such systems impractical for continuous use on a head-wearable device.

Furthermore, there is a technical problem associated with the high friction and inefficiency of traditional information retention methods. Currently, when a user wishes to remember a specific object or event, they must manually initiate a capture, such as by taking a photograph with a smartphone or writing a digital note. This requirement for active user intervention creates a technical problem where important information is often lost because the user did not anticipate the future need for the memory at the time of the event. Even when information is captured, existing digital solutions often lead to fragmented data that is difficult to organize and retrieve later. For example, a user who takes a photo of a parking spot or a prescription bottle must later navigate through an unorganized library of images to find the specific detail they need. This process is computationally inefficient for the device and cognitively taxing for the user, as it requires manual tagging, searching, and sorting.

Current technologies have failed to address these technical problems because they lack a mechanism for passive, ambient perception that can intelligently distinguish between mundane data and salient memories worth preserving. Conventional systems are often context-blind, thus failing to understand the user's intent or the relevance of an object in the environment. Without a technical solution that can automatically filter data at the point of capture based on relevance to the user, computing devices either store too much irrelevant data, leading to the aforementioned memory and power issues, or they require constant user prompting, which is disruptive and inefficient.

The technical solution described herein addresses these technical problems by providing an ambient, multi-sensory memory augmentation system integrated into a head-wearable device. Rather than relying on continuous high-power recording or manual user intervention, the disclosed implementations utilize a tiered sensing architecture that identifies trigger conditions to trigger data capture. By operating sensors in a low-power ambient mode to identify predetermined signals, such as specific objects, trigger words, or inertial patterns, the system provides a technical solution that minimizes power consumption while ensuring that salient information is captured. This approach shifts the burden of memory organization from the user to the computing device, utilizing automated identification and structured storage to build a retrievable memory bank without exhausting device resources.

In some implementations, the technical solution involves a sophisticated storage and retrieval framework that utilizes a multi-tiered memory architecture including on-device memory, mobile device storage, and cloud-based memory. By implementing a multi-sensory cache, the system can store a first portion of data, such as a high-resolution image of a misplaced item, based on the context provided by a second portion of data, such as a user’s gaze or a verbal comment. To optimize power consumption and storage resources, the system may implement a tiered transfer logic. Data may be initially captured and stored in a memory buffer on the head-wearable device. Based on logistical factors such as power state, memory buffer capacity, or a connection state, the data may then be batched and transferred to a connected mobile device. This batching process minimizes the frequency of high-power transmission events, thereby extending the battery life of the wearable device. Subsequent transfer from the mobile device to the cloud-based memory may occur after a longer period of time, ensuring a persistent and accessible record while maintaining device efficiency.

This technical solution may further incorporate a personalized context module that refines what is considered a salient entity based on user history and preferences. Before data is transferred from the wearable device, the system may perform filtering operations, such as removing frames that are blurry or overly similar to previous captures, to ensure only high-quality and unique information is preserved. Furthermore, the system can dynamically adjust sensor parameters, such as increasing a frame rate of a visual sensor in response to identifying a level of audio activity that meets a specific criterion. When a user submits a query to a conversational agent, the system performs ad hoc or ubiquitous retrieval to find the most relevant stored memories, feeding them into a visual language model to generate an accurate response. This framework provides a technical solution to the problem of fragmented data by creating a semantically linked map of entities and their surrounding environmental context, all while operating within a privacy-first architecture that utilizes encrypted private vaults and on-device data scrubbing to protect sensitive user information.

The disclosed technology provides several advantageous technical effects that improve the functionality of wearable devices and the user experience. A primary technical effect is the optimization of battery life and storage capacity through trigger condition filtering. By only triggering persistent storage when a salient entity or event is recognized, the system achieves the technical effect of offering long-term memory augmentation while maintaining a low power profile suitable for wearable use. Another advantageous technical effect is the reduction of latency and improvement in accuracy during memory retrieval. By storing data alongside contextual metadata and using similarity metrics for ad hoc queries, the system can pinpoint specific memories within a vast data set much faster than conventional search methods, providing a seamless photographic memory experience.

Additionally, the system provides a technical effect by implementing technical safeguards for user privacy through a privacy-first architecture. Before data is stored in a persistent storage device, a local identification module may perform on-device data scrubbing to identify and mask sensitive information, such as faces, sensitive text strings such as those containing passwords or audio from bystanders. This scrubbing process may utilize a lightweight computer vision model running on the head-wearable device or a connected mobile device, to blur, remove or block identified sensitive regions from the visual data stream (e.g., faces). By performing this filtering at the point of capture, prior to batching for transfer or at the mobile device, the system ensures that the augmented memory remains secure and compliant with user-defined privacy parameters. The use of a private vault architecture, where data is encrypted on-device and remains encrypted during transit, provides the technical effect of balancing the utility of ambient recording with robust data protection.

Practical uses and applications for this technology are extensive, particularly in the realm of daily personal assistance and object tracking. For instance, a user who frequently misplaces items like keys, wallets, or glasses can simply ask a conversational agent, "Where did I last have my keys?" The system, having passively identified and stored an image of the keys on a kitchen counter earlier in the day, can retrieve the specific frame and provide the user with the exact location and time the object was seen. This application transforms the wearable device into a proactive assistant that mitigates the common human error of forgetfulness.

In another practical application, the technology can be used for environmental and situational recall. A user visiting a new city or attending a professional conference may encounter names of buildings, titles of books on a shelf, or specific details in a presentation. By ambiently perceiving these entities, the system allows the user to later perform queries such as, "What was the name of that cafe with the blue awning I walked past this morning?" or "Do I already have a copy of the book I saw at the library?" The system can process the stored visual and location data to provide an accurate answer, effectively augmenting the user's ability to retain and utilize information from their physical environment. The stored information may relate to health and wellbeing. For example, the system may track what the user has eaten or drank, or help the user understand how long they have stared at screens and the like. The system may also provide proactive information based on the stored information. In an example, the system may display the bathroom code the user recently held as the user approaches the bathroom. In another example, this may involve reminding the user that they had a backpack when they entered a car when the user is about to exit. Another example may involve reminding the user that they have not watered their plant or closed their garage door.

Furthermore, the technology is highly applicable to task management and active memory enrollment. For example, a user can explicitly instruct the device to remember a specific event, such as "Remember that I watered the plants," or the system can implicitly identify significant actions, such as a user placing a passport in a drawer before a trip. By joining memory data with other digital contexts such as calendar events or emails, the system can provide proactive suggestions, such as reminding a user where they stored their passport as their flight time approaches. This level of integrated, context-aware memory retrieval provides a tangible benefit for users navigating complex daily schedules and information-heavy environments.

The term “wearable device” as used herein refers generally to any computing device designed to be worn on a user's body and includes head-wearable devices. Examples of head-wearable devices include smart glasses, augmented reality (AR) headsets, virtual reality (VR) goggles, or XR visors. A head-wearable device typically includes a frame that supports one or more sensors, such as cameras and microphones, positioned to capture data from the user’s point of view. For example, a pair of smart glasses may include an outward-facing camera to capture visual data and an integrated display to provide an overlay of digital information onto the physical world. While this document describes and illustrates smart glasses style wearable devices, it is understood that a wearable device may include other body worn devices that can capture multimodal data from a user’s point of view.

The term “trigger condition” as used herein refers generally to a technical trigger identified within a sensor data stream that indicates the presence of a salient entity or event worth being stored in a memory. A trigger condition may include a low-power identification of a predefined object in a camera frame, the identification of a trigger word in an audio stream, or a specific movement pattern detected by an inertial measurement unit. For example, the recognition of a wallet or keys in a low-resolution ambient video feed may serve as a trigger condition that triggers the system to capture and store a high-resolution version of that data for future retrieval.

The term “conversational agent” as used herein refers generally to an artificial intelligence (AI) system or model configured to receive user input and generate human-like responses. A conversational agent may be implemented using a large language model (LLM) or a visual language model (VLM) capable of processing multi-modal inputs, such as text, audio, and/or images. For example, a conversational agent on a wearable device may receive a voice query from a user, retrieve a stored memory from a cloud-based cache, and synthesize an answer that describes the content of a previously captured image.

The term “ubiquitous memory” or “persistent memory” as used herein refers generally to a category of stored data that is identified as being consistently relevant to a user based on criteria such as frequency of interaction or explicit user designation. Persistent memories are often pre-fetched or automatically included in the context of an agent session or interaction. Persistent memories often include persistent personal preferences, high-priority entities identified in an entity registry, or recurring environmental states that are not tied to a specific time-bound query. For example, if a user informs the system that their favorite color is blue, this information is stored as a persistent memory and is made available to a conversational agent to refine future responses prior to the execution of an ad hoc search.

The term “ad hoc retrieval” as used herein refers generally to the technical process of searching a memory bank for specific data in response to a particular user query or situational need. Ad hoc retrieval typically involves calculating a similarity metric, such as cosine similarity, between the embeddings of a user’s current query and the embeddings of stored memories to find the most relevant match. The similarity may be determined based on a criterion such as a threshold. For example, if a user asks about the location of a specific book, the system performs ad hoc retrieval to scan thousands of stored memory frames for the one containing the title of that book.

The term “entity” as used herein refers generally to a specific item of interest, such as an object, object or spoken keyword, that is explicitly enrolled in a system registry and is detectable within an incoming multimodal data stream. An entity may be an identifiable semantic target that serves as a trigger for memory storage or retrieval.

The term “contextual data” or “context” as used herein refers generally to supplementary environmental, temporal, and/or spatial information captured concurrently with primary sensor data that characterizes the circumstances under which the primary data was recorded. For example, contextual data may include metadata derived from secondary sensor or historical user interaction patterns that provide situational meaning to a contemporaneously identified object or event.

The term “connected device” as used herein refers generally to a secondary computing device that is physically separate from the head-wearable device but communicatively coupled to it via a local wireless or wired connection to provide intermediary data storage.

The term “map” as used herein refers generally to a structured relational data representation that semantically links a primary captured data (e.g., a file) with related contextual metadata (e.g., temporally or spatially related metadata) facilitating contextual search and ad hoc retrieval.

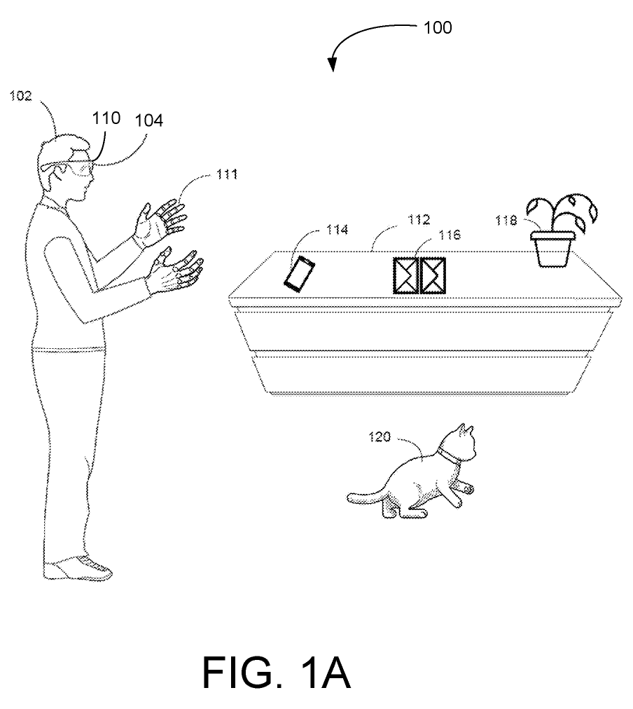

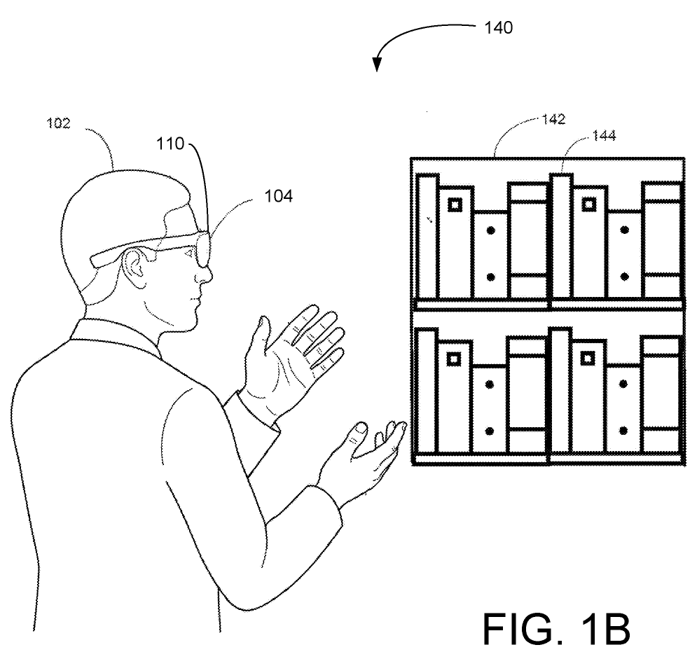

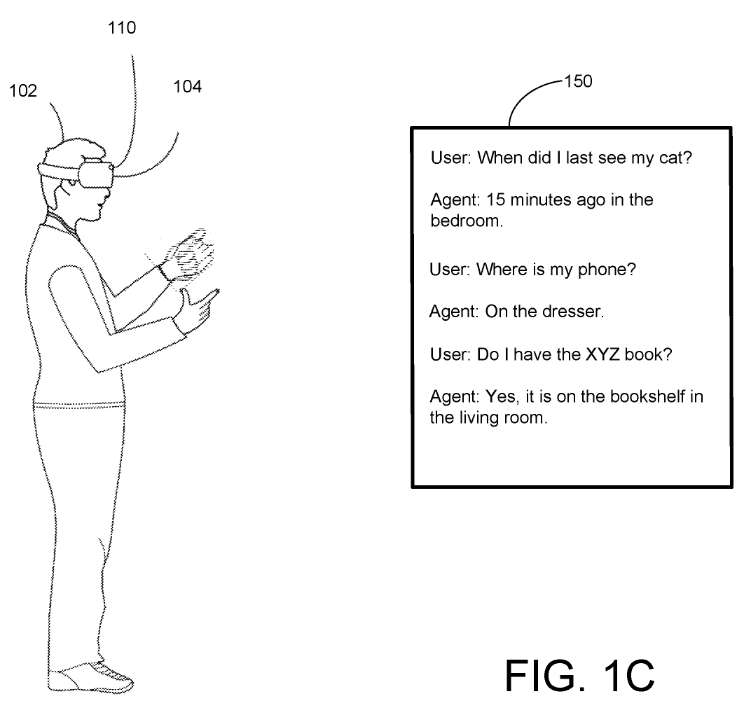

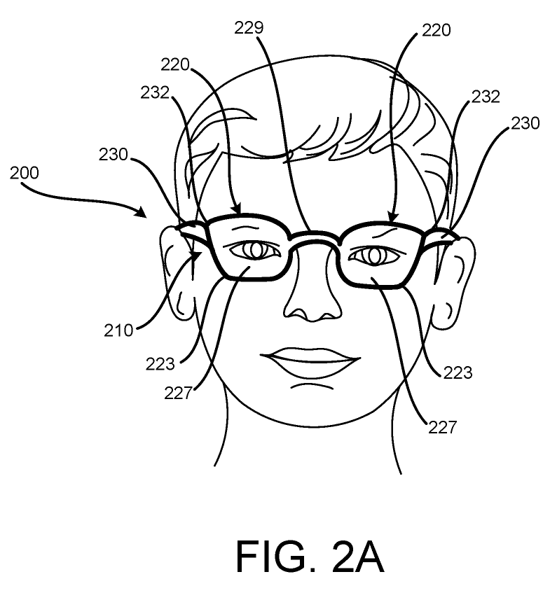

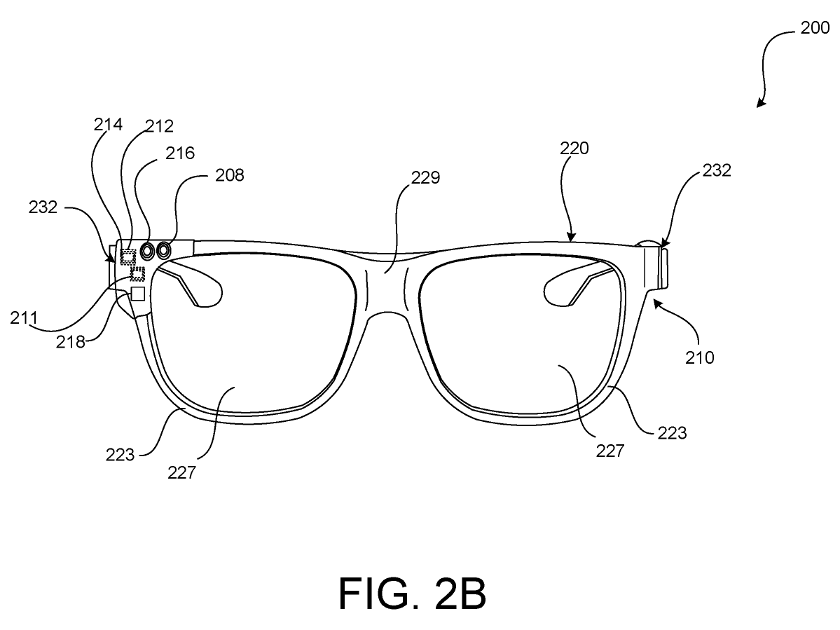

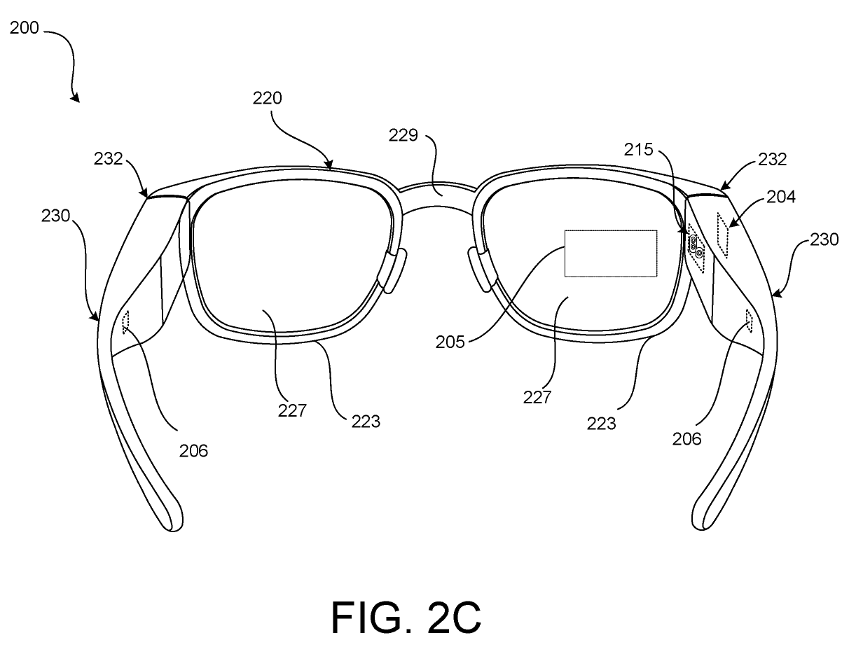

FIGS. 1A-2B depict example memory augmentation environments in which a user wears a head-wearable device in a physical environment, and the head-wearable device responds by storing details about the physical environment in a memory, according to an aspect. FIG. 1A illustrates an example memory augmentation environment 100 in which a user 102 wearing a head-wearable device 104 is looking around in the environment 100. The environment includes a dresser 112 on which a few objects are located. The objects include a phone 114, envelopes 116 and a plant 118. The environment also includes a cat 120.

The head-wearable device 104 is worn by (e.g., mounted on a head of) the user 102. In some implementations, the head-wearable device 104 includes smart glasses that project images onto lenses of the smart glasses to generate an overlay of images over the physical environment beyond the smart glasses. In some implementations, the head-wearable device 104 includes a headset that encloses eyes of the user 102 and includes a left display for a left eye of the user 102 and a right display for a right eye of the user 102 to present an immersive environment for the user 102.

The head-wearable device 104 includes one or more sensors 110 that face away from the eyes of the user 102 to capture images, videos and/or other data related to the environment from the point of view of the user 102. The head-wearable device 104 may include a memory augmentation system (not shown) that instructs the sensor 110 to capture images of objects in front of the user 102 as the user walks and/or looks around the environment 100. For example, the sensor 110 may capture an image of the dresser 112 that displays the phone 114, the envelopes 116 and the plant 118 on the dresser 112. If the user looks down or via a camera that is facing downwards, the head-wearable device 104 may also capture an image of the cat 120. These images may be taken during a passive mode as the user is simply looking around the room. The images may be stored in an on-device memory for a limited time period and may be transferred to a personal device (e.g., a mobile phone or tablet) or cloud-based memory for longer storage. In an example, the images are stored along with metadata that provides information about the context of the images. For example, the time and/or location at which an image is captured. The images may be used later when the user has a query that relates to an object in one of the stored images.

In addition to the sensor 110, the head-wearable device 104 may also include a microphone for capturing audio data from the environment. Furthermore, the head-wearable device 104 may include other sensors such as IMUs for capturing additional data about the environment. The captured data may be stored in a manner that enables easy retrieval and processing as further discussed below.

In some implementations, the sensor 110 captures data at a low sampling rate and the head-wearable device 104 determines if there are any objects or events within the environment that are trigger conditions indicating that a memory related to the environment should be stored. Once a trigger condition such as the presence of the phone 114 or the cat 120 is identified, the sensor 110 or a different sensor may capture data at a higher sampling rate and store the data captured at the higher sampling rate.

FIG. 1B depicts another example environment in which a memory augmentation system may be used to capture data about the environment. The environment 140 includes a bookshelf 142 on which several books 144 are displayed. As the user 102 faces the bookshelf 142, while wearing the head-wearable device 104, the head-wearable device 104 may capture an image of the bookshelf with the books for later retrieval and use. In some examples, data may be captured based on specific user input. For example, the user may instruct the head-wearable device 104 to capture an image of the bookshelf or record an audio note of a sound being heard in the environment. In other examples, the user may provide a list of trigger conditions that the user is interested in capturing for later use. For example, a user may indicate that anytime the head-wearable device 104 encounters the user’s mobile device, wallet or keys, a picture should be taken. Furthermore, the memory augmentation system may make use of a model that is trained to identify trigger conditions that a given user may be interested in capturing. For example, a trained model may be used to identify objects that are important to users to remember. In another example, the model may be able to identify specific locations that may be important for users to remember in the future. Alternatively, the memory augmentation system may simply capture images of the user’s environment and store the images for future use for specific periods of time even when no trigger condition is encountered. This may occur, for example, based on specific user input (e.g., a user instructs the system to capture images and/or videos of the environment for the next 5 minutes) or based on a determination that an event is likely to have relevance to a user.

FIG. 1C depicts an example memory augmentation environment in which stored memories are retrieved for a user. Sometime after the user 102 has left the environments 100 and 140 of FIGS. 1A-1B (or even when the user is still present there), the user may have queries that relate to data captured in the environments 100 and 140. For example, the user 102 may not be able to find their cat and may wonder when the last time was that the user 102 saw the cat. The user 102 can invoke a conversational agent via the head-wearable device 104 to ask the agent a question about the cat. For example, the user 102 may ask the conversational agent “when did I last see my cat?” In response, the conversational agent may retrieve data stored by the memory augmentation system and process the data to find recent data that indicates the presence of a cat. An example of data that indicates the presence of a cat is audio data and/or embeddings from audio data that indicate the presence of a cat (e.g., audio data that includes a cat meow or cat purr or an image or image embeddings that indicates presence of the cat). The system may identify the time at which the data was captured, determine spatial context (e.g., the location was the living room) and then provide the user with a relevant and accurate response. Data may be stored as text tokens, localization related tokens (e.g., indoor, outdoor or other spatial context), data from inertial sensors that interpret activity detection in a context window, and/or audio data that can be detected from even outside of the camera field of view.

In another example, the user 102 may ask the conversational agent where their phone is. The conversational agent can query the memory for images that include mobile phones and retrieve and process the images to determine that the user’s phone was last observed on the dresser. Similarly, the user may query the conversational agent about a book they are looking for by for example asking, “do I have the XYZ book?” The conversational agent may retrieve the image of the bookshelf 142 with the books 144, recognize the titles of the books 144 in the image and provide a relevant response to the user 102. The conversations with the agent may be displayed in a user interface element 150 and/or may be done via audio signals.

FIG. 2A illustrates a user wearing an example head-wearable device 200 in the form of smart glasses, or XR glasses, including display capability, eye/gaze tracking capability, and computing/processing capability. FIG. 2B is a front view, and FIG. 2C is a rear view of the example head-wearable device 200 shown in FIG. 2A. The example head-wearable device 200 includes a frame 210. The frame 210 includes a front frame portion 220, and a pair of arm portions 230 rotatably coupled to the front frame portion 220 by respective hinge portions 232. The front frame portion 220 includes rim portions 223 surrounding respective optical portions in the form of lenses 227, with a bridge portion 229 connecting the rim portions 223. The arm portions 230 are coupled, for example, pivotably or rotatably coupled, to the front frame portion 220 at peripheral portions of the respective rim portions 223. In some examples, the lenses 227 are corrective/prescription lenses. In some examples, the lenses 227 are an optical material including glass and/or plastic portions that do not necessarily incorporate corrective/prescription parameters.

In some examples, the head-wearable device 200 includes a device display 204 that can output visual content, for example, at an output coupler 205, so that the visual content is visible to the user. In the example shown in FIGS. 2B and 2C, the device display 204 is provided in one of the two arm portions 230, simply for purposes of discussion and illustration. Device displays 204 may be provided in each of the two arm portions 230 for binocular output of content. In some examples, the device 204 may be a see-through near eye display. In some implementations, the device 204 may be configured to project light from a display source onto a portion of teleprompter glass functioning as a beamsplitter seated at an angle (e.g., 30-45 degrees). The beamsplitter may allow for reflection and transmission values that enable the light from the display source to be partially reflected while the remaining light is transmitted through. Such an optic design may allow a user to see both physical items in the world, for example, through the lenses 227, next to content (for example, digital images, user interface elements, virtual content, and the like) output by the device display 204. In some implementations, waveguide optics may be used to depict content on the device display 204. The device display 204 may be used to display previously captured images to the user. The device display 204 may also be used during interactions with the conversational agent for example, by displaying the content of the conversation.

In some examples, the head-wearable device 200 includes one or more of an audio output device 206 (such as, for example, one or more speakers), an audio input device 208 (such as a microphone), a sensing system 211, a control system 212, at least one processor 214, a memory 218, and at least one outward facing visual sensor or camera 216. In some implementations, the outward facing visual sensor or camera 216 is part of the sensing system 211. In some examples, the sensing system 211 may include various sensing devices and the control system 212 may include various control system devices including, for example, at least one processor 214 operably coupled to other components of the control system 212. In some examples, the control system 212 may include a communication module providing for communication and exchange of information between the head-wearable device 200 and external devices such as a mobile device and/or cloud-based memory.

In some implementations, the processor 214 includes multiple processors, and memory 218 includes multiple memories. The processor 214 may be in communication with the camera 216, sensing system 211, audio input device 208 and other modules and electronics of the wearable device 200. The processor 214 is configured by instructions (e.g., software, application, modules, etc.) to display content or execute any modules included on the wearable device 200. The instructions may include non-transitory computer readable instructions stored in, and recalled from, memory 218. In examples, the instructions may be communicated to the processor 214 from a computing device or from a network (not pictured) via the communication module of the control system 212. Moreover, the processor 214 may be in communication with the device display 204. For example, the processor 214 may be configured by instructions to transmit text, graphics, video, images, etc. to the device display 204. The processor 214 may also be in communication with the memory 218 and may instruct the memory to store data and/or may retrieve data from the memory 218. In some implementations, the processor 214 may be in communication with an external memory and may instruct the communication module to retrieve data from the external memory.

The communication module of the head-wearable device 200 may be operable to facilitate communication between the head-wearable device 200 and other computing devices, such as desktop computers, laptop computers, tablet computers, smart phones, wearable computers, servers, or any other type of computing device to perform operations such as storing to a cloud-based memory or retrieving data from a cloud-based memory. In some examples, the communication module utilizes Bluetooth, Wi-Fi, Zigbee, or any other wireless or wired communication methods to communicate with other devices.

The sensing system 211 may include one or more capacitive touch sensors. The capacitive touch sensors may be located on one or both of the temple arm portions 230. In some examples, two capacitive touch sensors may be disposed in one of the temple arm portions 230. In some examples, one or more capacitive touch sensors may be located on other portions of the frame 210.

The sensing system 211 also may include a motion sensor, which may be implemented as an accelerometer, a gyroscope, and/or magnetometer, some of which may be combined to form an IMU. In some examples, the motion sensor may be implemented as a three-axis motion sensor such as, for example, a three-axis accelerometer or a three-axis gyroscope, where the motion signals captured by the motion sensor describe three translation movements (i.e., x-direction, y-direction, and z-direction) along axes of a world coordinate system. In some examples, the motion sensor may be implemented as a six-axis motion sensor such as, for example, an IMU that has six (6) degrees of freedom (6-DOF), which can describe three translation movements (i.e., x-direction, y-direction, and z-direction) along axes of a world coordinate system and three rotation movements (i.e., pitch, yaw, roll) about the axes of the world coordinate system.

The sensing system 211 may also include one or more proximity sensors. In some examples, the proximity sensors are optical proximity sensors. The proximity sensors may be located on one or both of the temple arm portions 230. In other examples, the proximity sensors are located on other portions of the frame 210.

In some implementations, the head-wearable device 200 includes a gaze tracking device 215 to detect and track eye gaze direction and movement. Data captured by the gaze tracking device 215 may be processed to detect and track gaze direction and movement as a user input. The gaze tracking data may be used in determining when and/or where to capture sensor data that should be stored in memory. For example, the user’s gaze direction may be used to capture images of objects the user is actively looking at. In the example shown in FIGS. 2B and 2C, the gaze tracking device 215 is provided in one of the two arm portions 230, simply for purposes of discussion and illustration. In the example arrangement shown in FIGS. 2B and 2C, the gaze tracking device 215 is provided in the same arm portion 230 as the device display 204, so that user eye gaze can be tracked not only with respect to objects in the physical environment, but also with respect to the content output for display by the device display 204. In some examples, gaze tracking devices 215 may be provided in each of the two arm portions 230 to provide for gaze tracking of each of the two eyes of the user. In some examples, device displays 204 may be provided in each of the two arm portions 230 to provide for binocular display of visual content.

The control system 212 may include one or more models such as, for example, one or more machine learning models that are executed locally by the processor 214. In some implementations, the models may be trained to determine when to capture and store data, what type of memory to store a given type of data in, the amount of time captured data should be stored and/or the type of contextual data or other sensor data that should be stored along with the data.

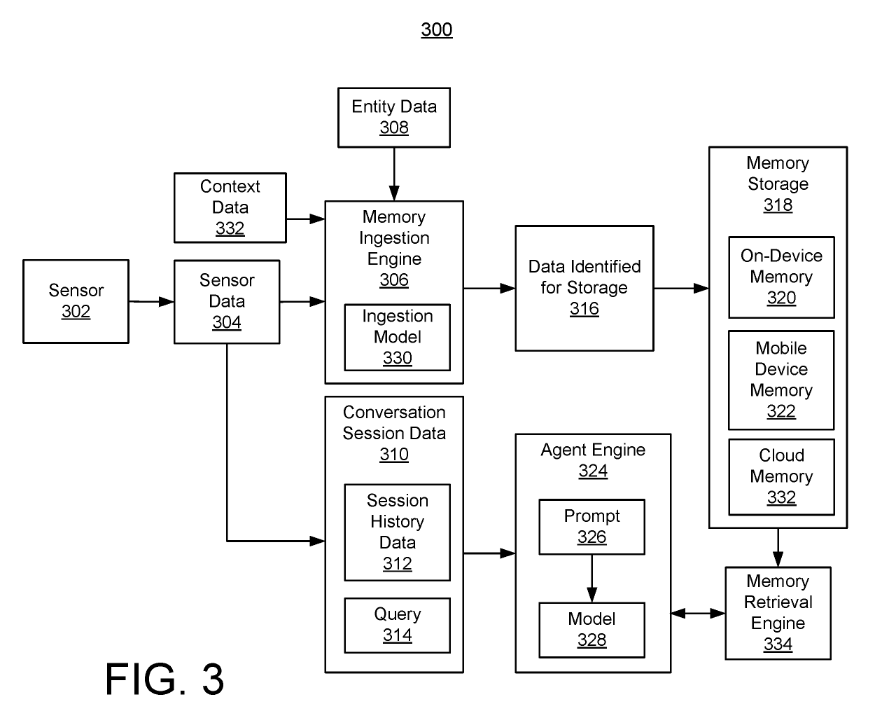

FIG. 3 depicts a block diagram of a memory augmentation system 300, in accordance with an example. Some of the elements of the memory augmentation system 300 may be included in a wearable device such as the wearable device 104 of FIGS. 1A-1C and wearable device 200 of FIGS. 2A-2C. Other components may be in remote devices.

The memory augmentation system 300 includes a sensor 302 which may include multiple sensors such as a visual sensor, an audio sensor, a location sensor and/or other sensors. The sensors in the sensor 302 may capture sensor data 304 from the environment based on the user’s point of view. For example, the visual sensor may capture images and/or videos of scenes that the user is gazing at or viewing. In some examples, the memory augmentation system 300 may make use of multiple visual sensors to capture data from multiple points of view. Different visual sensors may capture different types of images and/or capture different views. For example, Near-Infrared (NIR) cameras, Long Infrared (Long IR) cameras, and other types of cameras may be used.

In some implementations, in addition to or instead of a visual sensor, an audio sensor may be used. The audio sensor may include one or more microphones that capture audio data from the user’s environment. In some examples, other sensors are also used that capture data relevant to the user’s environment such as altitude, location, temperature, motion, orientation and/or physiological data (e.g., heart rate). Thus, sensor data 304 may include visual data, audio data, or other data related to the user’s environment or the user such as latitude, location, temperature, motion, orientation and/or physiological data.

In some implementations, the memory augmentation system 300 may include a memory ingestion engine 306, which may receive and process sensor data from one or more sensors. For example, the memory ingestion engine 306 may receive sensor data 304 from any combination of the sensors 302 (e.g., visual, audio and other sensors) and process the data to determine if any of the sensor data 304 should be stored in memory. The memory ingestion engine 306 may receive and preprocess the sensor data 304 before transmitting the data to an appropriate module for further processing. The memory ingestion engine 306 may include one or more models such as the ingestion model 330 that recognize predetermined signals in the captured sensor data 304 to determine if the sensor data 304 should be stored. In an example, the ingestion model 330 includes at least one of an object recognition model, speech-to-text model, and/or a large language model.

In some examples, the ingestion model 330 examines several sensor data 304 and/or contextual data to determine whether the sensor data 304 should be stored. For example, data from a gaze tracking sensor may be examined alongside an image captured by a visual sensor to determine if the user was looking at a certain object for longer than a predetermined threshold amount of time (e.g., longer than 5 seconds). The image may then be examined to determine if the image contains the object of interest and if so, the image may be flagged for storage. Context data may also be examined in determining whether data captured by the sensor 302 should be stored in memory. For example, date/time, location, altitude, and/or historical usage data by the user may be examined to identify patterns that indicate a likelihood of the sensor data 304 being relevant to the user. In some implementations, various sensor data 304 are examined together to make the determination. For example, audio data may indicate that the user is interested in an object (e.g., the user saying “I really like this book”). This may lead to sensor data 304 captured by a visual sensor being examined to identify the object in the visual data captured around the same time as the user made the comment. Once the image containing the object is identified, it is flagged for storage. As such, user intent and attention may be determined from one or more of the captured sensor data and/or context data and used in determining whether a memory (sensor data) should be stored for future use. In some implementations, the criteria for determining relevance of data to the user includes presence of a predetermined signal (e.g. a previously identified object, specific words, etc.) or presence of an entity in the data that meets a similarity criterion.

In some implementations, in addition to context data and/or other sensor data 304, entity data 308 is also used in determining if sensor data 304 should be stored in memory. Entity data 308 may be stored in an entity registry datastore. The registry data store may include a list of objects that the user interacts with on a daily basis. Objects on the list may be explicitly identified by the user (e.g., via a feature or setting of an application) and/or may be identified using a model or other mechanism that identifies objects of interest to a user. The process of explicitly identifying objects or other triggers may be referred to as an entity enrollment, where the user may identify entities of interest and/or associate some entities with others. In an example, objects of interest include keys, laptop, notebook, mobile phone, wallet and the like.

In addition to objects, the entity registry database may also include a list of other types of predetermined signals (also referred to herein as trigger conditions). For example, the entity data 308 may include a list of trigger words that operate as predetermined entities for audio data. In an example, these words include keys, mobile phone, cell phone, wallet, and the like. The predefined words may be identified by a model or may be explicitly registered in the entity registry datastore by the user. The entities included in the entity data 308 may be updated as the models receive updated training and learn more about the user(s). Moreover, user intent may be determined and considered in identifying and storing entities in the entity data 308. For example, sensor data 304 relating to user intent (e.g., user gaze, user pointing, user holding an object, etc.) may be collected and examined to take into account user intent as a trigger for memory storage. User intent may further be determined from textual data the user may use to describe their interactions with an agent or in an application.

In some implementations, sensor data 304 may be captured during either a passive mode or an active mode of operation of the device. During a passive mode, one or more sensors 302 may operate in a low power mode (e.g., capturing data continuously or based on a predetermined schedule regardless of whether the user is actively interacting with the device). During the low power mode, the sensors 302 may capture low resolution data and transmit the data to the memory ingestion engine 306, other predetermined signal recognition mechanisms and/or a low-power identification module. The predetermined signal recognition mechanism may be a classifier or a model (e.g., a lightweight model) that examines the sensor data 304 to determine presence of predetermined signals in the data. The predetermined signal recognition mechanism may be different for different types of sensors. For example, data captured by a visual sensor may be transmitted to a low power object recognition mechanism (e.g., lightweight object detection model) that can be executed on the wearable device to determine the presence of a predefined set of objects (e.g., objects identified in entity data 308).

Data captured by an audio sensor may be transmitted to a speech recognition mechanism for converting speech-to-text and then another model or classifier may be used to determine if the audio data contains subjects of interest. In another example, a model or classifier may be used to identify a level of audio activity that meets a criterion, such as a sudden increase in decibels or a specific trigger word. Additionally, the system may identify movement patterns from an IMU to determine if the movement patterns meet a threshold, such as a specific gesture (e.g., a gesture indicating the user desires storage of a memory). In response to the identification of such trigger conditions, the system may trigger a higher power capture mode, such as by increasing a sampling rate or frame rate of a visual sensor to ensure high-fidelity recording of the salient event.

In some implementations, in addition to an object recognition system, a speech recognition system and/or another predetermined signal recognition mechanism, a model is utilized that receives the recognized object(s), recognized speech, other recognized predetermined signals and/or additional context as input and determines if at least some of the captured sensor data 304 should be stored based on a combination of factors and/or contextual information.

In some implementations, at least some of the sensors 302, such as IMU sensors, location sensors, and the like are continuously capturing data in a low power mode and capture either a Boolean signal or other primitive values. Signals captured by these may include a Boolean signal, categorical value or a combination of Boolean and categorical values from multiple sensors. In an example, data captured by these sensors is stored in a text format or converted to a text format when retrieved for use by a model such as the ingestion model 330. In an example, the data is converted to an audio representation format before being provided as an input to the model. For example, the input may be text or audio data that states “the accelerometer value was greater than the predefined threshold value at 3:30 pm on Apr. 24, 2025.” Predetermined signals from other sensors 302 may include specific values for the signals. The data from the sensors 302 (including the sensors that continuously capture primitive values) may be transmitted to one or more predetermined signal recognition mechanisms to identify the presence of triggers (e.g., predetermined signals) in the sensor data 304.

In some implementations, triggers include entities stored in the entity data 308, trigger conditions in the sensor data (e.g., explicit user request to store an image), entity saliency and/or spatial memory in the captured sensor data 304. Entity saliency may refer to entities that are either selected by a model (e.g., based on context data) or predefined by the user. Some wearable devices include on-device sensors having the ability to recognize such entities. That is, some sensors 302 may include on-device models or classifiers that can process the sensor data to identify specific entities. Spatial memory and recall may refer to sensor data that includes visual spatial indicators (such as translation and depth) as well as auditory field spatial indicators (such as azimuth and elevation). When the predetermined signal recognition mechanism (e.g., model 330 or on-sensor model) identifies the presence of a trigger in the sensor data 304, the captured data is identified as data identified for storage 316 and is transmitted for storage to the memory storage 318.

The memory storage 318 includes an on-device memory 320 (e.g., on- device cache), which may store data for a limited time period, a mobile device memory 322, and a cloud memory 342, which may store data for a longer period of time. The mobile device memory 322 may include memory on a connected device (e.g., a mobile phone, laptop or other device that is connected to the wearable device via a local connection). The period of time the data is stored may vary depending on the types of data, the settings of the wearable device, and other factors. In an example, the user can provide input via a customizable settings value regarding the amount of time the user desires to store certain types of data. For example, the user may indicate that any images that include keys should be stored for a week, while images that include mobile phones should be stored for only one day.

The memory storage 318 implements a multi-tiered architecture designed to balance immediate accessibility with long-term persistence across on-device memory 320, mobile device memory 322, and cloud memory 342. Data initially captured by the sensors 302 is stored in a memory buffer or temporary cache on the head-wearable device. This on-device storage is typically reserved for a limited time period or until a memory buffer capacity is reached. To optimize power consumption, the system may utilize a tiered transfer logic where data is batched rather than transmitted continuously. These batches may be transferred from the wearable device to a connected mobile device, such as a smartphone, based on logistical factors including the power state of the wearable device, the current connection strength, and the available buffer space. In some implementations, the system manages the delivery of data from the head-wearable device to a connected mobile device based on logistical factors including a power state, connectivity strength, and/or a storage cadence. For example, the system may delay transmission until a high-bandwidth connection is established to avoid the battery drain associated with frequently transitioning the communication module between low-power and high-power states. This batching process allows the wearable device to maintain a lean power profile while ensuring that salient data is eventually offloaded to the mobile device memory 322 for further processing or cloud synchronization.

In some implementations, the memory augmentation system 300 further comprises a memory identification module (not shown) configured to manage user privacy through a privacy-first architecture. Before any sensor data 304 is committed to persistent storage, such as the cloud memory 342, the memory identification module performs on-device data scrubbing to identify and mask sensitive information. This scrubbing process may utilize a lightweight computer vision model or a text-recognition model running locally on the head-wearable device to identify sensitive regions, such as faces, license plates, or text strings containing passwords. Once identified, these sensitive regions are blurred, excised, or otherwise encrypted before the data is batched for transfer to the mobile device memory 322 or cloud memory 342. By performing this filtering at the point of capture or prior to long-term storage, the system provides a technical safeguard that ensures the augmented memory remains secure and compliant with user-defined privacy parameters. This on-device scrubbing ensures that personally identifiable information is removed or obscured before the data leaves the local control of the wearable device, balancing the utility of ambient recording with robust data protection.

Once the data is residing on the mobile device, it may be stored for a longer duration compared to the wearable device's local cache. The mobile device serves as an intermediary storage layer, potentially performing additional filtering operations, such as removing blurry frames or images that are substantially similar to previously captured data, before the information is eventually synced to cloud-based memory. This transfer from the mobile device to the cloud occurs after a longer period of time, ensuring a persistent and universally accessible record. Furthermore, the system may utilize a secure private vault architecture within the cloud-based memory, where data is encrypted on-device and remains accessible only via specific authentication chains tied to the user's account and device.

The timing and frequency of these data transfers are dynamically adjusted to maintain device efficiency. For instance, the system may delay high-power transmission events until a stable Wi-Fi connection is established or until the wearable device is connected to a power source. Conversely, if the system identifies a high-priority trigger condition or a specific user-requested memory enrollment, it may prioritize the immediate transfer of that specific data. By managing data across the wearable device, mobile device, and cloud in this manner, the system provides a continuous rolling context window for memory retrieval while minimizing the battery drain associated with frequent wireless radio activation.

The data identified for storage 316 may be stored in a format that is easily retrievable. In an example, the data is provided to one or more models (e.g., the ingestion model 330 or a separate model) that extract features from the data, and the features are stored alongside or separately from the data to enable quick query and retrieval. For example, visual data (e.g., images) may undergo object recognition and encodings from the object recognition model may be stored alongside the visual data. Moreover, the captured data may be stored alongside contextual data and/or other sensor data 304 captured around the same time to provide context to the captured data and enable its retrieval at appropriate times. In some examples, storage involves creating a map of the data being stored along with other pieces of context that are relevant and/or useful to the user and can be used during retrieval. For example, storage may involve creating layers, entities, surrounding context associated with the entities and a layer of recommendations for the combination of the context and the entities. Context may include spatialized audio, voice activity detection (user talking), other sensor data such as activity of the user, location information, and the like.

In addition to the passive mode, data may also be captured and stored during an active mode of the wearable device. An active mode may refer to scenarios in which the user is actively interacting with the wearable device. For example, the user may be interacting with a conversational agent. In some implementations, during active mode, mechanisms that are operable during the passive mode are working in conjunction with an explicit active mechanism for capturing memories. For example, during the active mode, the memory augmentation system 300 may continuously provide the sensor data 304 using text modality (e.g., a pre-processing engine that converts the sensor data 304 to text) into a language model such as the model 328 of the agent engine 324. This may involve an explicit request and/or an implicit request.

Explicit request involves the user explicitly requesting that the agent remember something using text and/or audio input. Implicit request may involve the user ending a conversation with an agent and the agent, as a post conversation operation, identifying the captured data that should be remembered from the conversation for future use. In this scenario, the agent may be configured to output memories that are relevant for storage once a session ends. This provides the technical advantage of using a higher capacity model to determine which captured data should be stored. In an example, the memories that are stored based on an implicit request are limited to sensor data 304 that includes triggers such as trigger conditions in visual and/or audio sensor outputs.

In some implementations, the memory augmentation system 300 includes a conversation session data 310, session history data 312, and a query 314. The agent engine 324 is configured to process the stored memory, as well as real-time inputs using a prompt 326 and a model 328 to provide relevant information to the user. The session history data 312 receives a stream of sensor data 304 during an active mode, capturing the ongoing environmental context, while the query 314 captures the specific user request. Both the session history data 312 and the query 314 are output to the agent engine 324 to inform the generation of the prompt 326.

The prompt 326 and the model 328 within the agent engine 324 facilitate the retrieval and synthesis of stored information. The prompt 326 functions as an integrated input that combines the current query 314, session history data 312, and relevant memories retrieved from the tiered memory storage 318. The model 328, which may be a visual language model, receives the prompt 326 and processes the multi-modal information to generate an accurate response. By utilizing this architecture, the system can perform ad hoc retrieval from the memory storage 318 or utilize persistent memories stored in the memory storage 318 to provide the user with seamless memory augmentation.

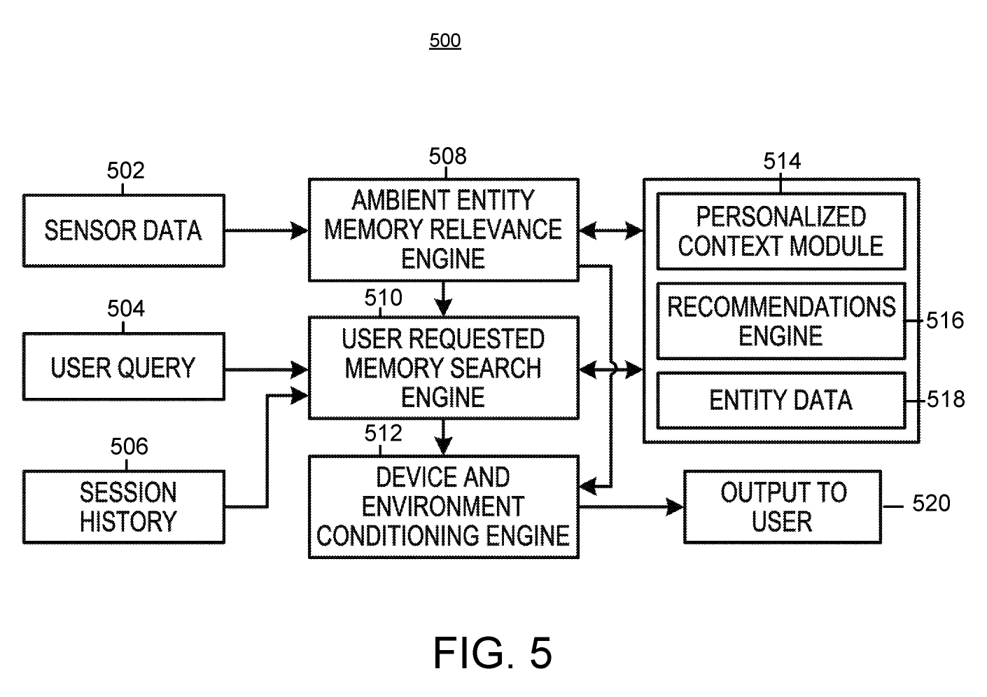

In some implementations, the system includes a memory retrieval engine 334, as shown in FIG. 3, which is configured to manage the access and extraction of information from the memory storage 318. The memory retrieval engine 334 receives requests for memory retrieval from the agent engine 324, typically triggered by a user query 314 or a proactive identification of relevance by the agent. To fulfill these requests, the memory retrieval engine 334 utilizes various technical mechanisms to scan and retrieve stored memories from the multi-tiered memory storage 318, including searching through the on-device memory 320, mobile device memory 322, or cloud memory 342. These retrieval mechanisms, which include processes for both ad hoc and ubiquitous retrieval based on similarity metrics and contextual relevance, are described in further detail with respect to FIG. 5. By interfacing between the conversational agent and the tiered storage architecture, the memory retrieval engine 334 ensures that the most relevant multi-modal data is surfaced to the user or provided as context for generating a response.

Retrieval of the stored memories may involve two types of retrieval, ubiquitous (global) retrieval and ad hoc retrieval. During ubiquitous retrieval, a set of predefined memories are retrieved and provided to the user and/or provided as input to the model 328, which may be involved in interacting with the user. For example, the predefined memories may be inserted into the context of a current conversation with a conversational agent. This may be achieved by marking certain captured data as ubiquitous memories during the capture and/or storage of the data. For example, during passive mode, trigger conditions from the sensor data 304 (e.g., visual data) that indicate the presence of a mobile phone may be marked as ubiquitous memories. Similarly, trigger conditions from other sensors or from an audio sensor that indicate the user is running may be marked as ubiquitous memories. In another example, during the active mode, the user specifies to the agent that their favorite color is red. This may be identified by the agent as a ubiquitous memory and stored as such for future retrieval.

During ad hoc retrieval, a similarity between ad hoc memories and a current user query 314 may be computed by the model 328 to determine if a memory should be retrieved. The current user query 314 may be stored in the conversation session data 310. The conversation session data 310 may include the current user query 314 as well as session conversation history data 312.

In determining the similarity, surrounding contextual data associated with the stored memories may also be taken into account. For different formats of memories, different methods for computing similarity values may be used. For example, for image or video frame memories, the user query embedding (either text or voice) may be computed and a similarity measure such as cosine similarity between the query embedding and frame embeddings (aggregator such as mean function for video snippets) may then be calculated. For text or audio memories, the embeddings may be computed for the memories and then a similarity with the query embedding may be calculated during retrieval. For non-media related memories, similarity may be computed based on the text/audio representation of the sensor data 304 and embeddings may be computed for those representations. A similarity may then be calculated between the embeddings and the query embedding. The similarity may then be compared to a criterion such as a threshold value to determine if the similarity meets the criterion.

Answering user queries related to the user memories may involve the use of an AI agent, such as the one represented by the agent engine 324. As discussed above, the agent engine 324 may include a model 328 which may be a visual language model and/or a large language model. The user may start a conversation session where multiple queries may be asked. In such a conversation session, once stored memories are retrieved, they are inserted into the input prompt 326 for the underlying model 328. This may involve using currently captured data, ubiquitous memories and/or ad hoc memories. For the user context that is captured in the current session through video, audio, and/or other sensors, the data may be made available in the prompt as the current session conversation history. The ubiquitous memories may be retrieved prior to the start of the session and included in the prompt 326. For ad hoc memories, they may be retrieved once the user asks a query, and the system 300 determines that the ad hoc memories are relevant to the user query. These memories are then retrieved and inserted into the prompt 326.

In some implementations, the memory augmentation system 300 utilizes an ongoing training process to refine the ingestion model 330 and the model 328 over time. As the system encounters a greater volume of sensor data 304 and diverse environmental signals, the models are updated to improve identification accuracy and the relevance of retrieved memories. This training may be driven by explicit or implicit feedback from the user. For instance, explicit feedback may occur when a user provides a direct correction to a conversational agent’s response or manually adjusts an entity within the entity registry. Implicit feedback may be derived from user interactions with the wearable device, such as the duration of a gaze dwell time on a specific object or the frequency with which a user queries the system about a particular entity. By analyzing these interaction patterns, the system can dynamically adjust the saliency of certain objects or update the semantic maps used for retrieval. This continuous learning loop ensures that the memory augmentation system 300 becomes increasingly personalized, effectively adapting to the specific habits, preferences, and environmental contexts of the individual user.

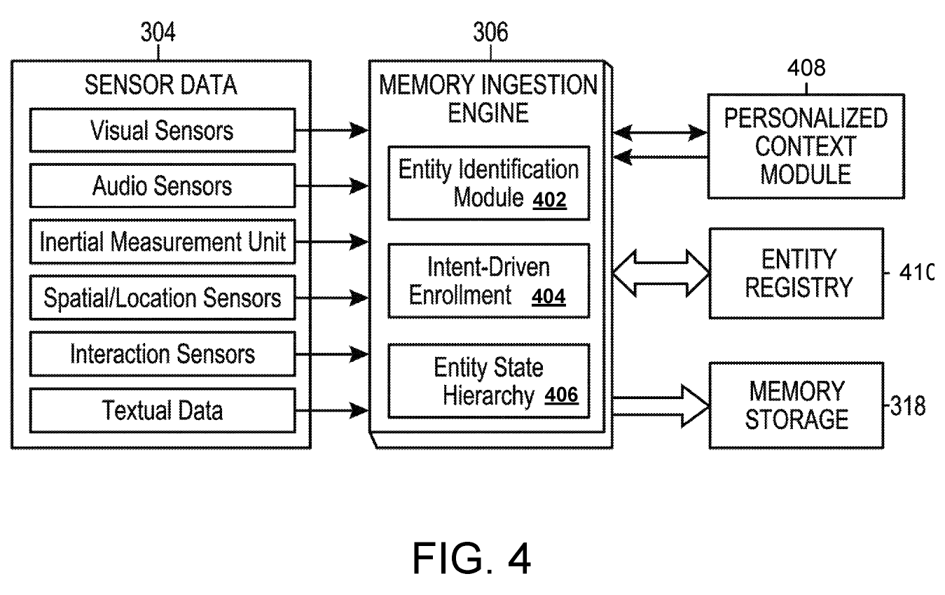

FIG. 4 is a block diagram of some elements involved in memory ingestion in a memory augmentation system, according to an aspect. The system utilizes a multi-sensory approach to identify salient entities and environmental context, ensuring that relevant information is efficiently filtered and stored for future retrieval while minimizing power consumption and storage requirements. As discussed above, the memory augmentation system can ingest multi-sensor data and identify entity information in the captured data based on contextual signals.

The sensor data 304 serves as an input for the memory ingestion engine 306. The sensor data 304 encompasses a broad range of multi-modal inputs, including visual sensors such as RGB and Near-Infrared (NIR) cameras, audio sensors such as standard and ultrasonic microphones, and an inertial measurement unit (IMU). Additionally, the sensor data 304 includes spatial and location sensors, such as Radar and Ultra-Wideband (UWB) sensors for indoor and outdoor localization, interaction sensors for capturing user intent through gaze dwell time, pointing, and/or holding objects, and textual data derived from conversation session histories. These diverse data streams are transmitted to the memory ingestion engine 306 to identify trigger conditions and/or salient entities.

The memory ingestion engine 306 may include several functional components that process the raw sensor data 304. Some of these components may be part of or in addition to the ingestion model 330 of FIG. 3. An entity identification module 402 (which may include one or more models) isolates salient items from the incoming streams, while an intent-driven enrollment unit 404 utilizes factors such as temporal context and user focus to determine the relevance of an entity. An entity state hierarchy 406 organizes these identified entities based on their current state and relative importance to the user.

The memory ingestion engine 306 maintains a bidirectional connection with a personalized context module 408, which aggregates data from multi-device applications and identifies temporal patterns to refine the identification process. Furthermore, a bidirectional connection exists between the memory ingestion engine 306 and the entity registry 410. The entity registry 410 may be connected or may include the entity data 308 of FIG. 3. The entity registry 410 may maintain a similarity index, semantic maps, and/or recommendation tags that allow the registry to relationally identify and enroll related entities. For example, if a user explicitly enrolls a pair of earbuds, the system may utilize semantic maps stored in the entity registry 410 to automatically identify and enroll related portable audio playback devices that the user interacts with subsequently.

Entities may be automatically recognized or user prescribed. Entities may be enrolled based on intent-driven enrollment where user intent is inferred based on a number of factors such as user gaze, location, temporal context and the like. Entity states may include a hierarchy of entities based on relevance. In an example, a similarity index for entities (with related functions) generates a semantic map of recommendation tags that are generated and stored with the entities. The memory ingestion identification model may communicate with or may function as the personalized context module 408, which aggregates context from multiple device applications, such as temporal patterns on a mobile device or web browser associated with a user account. Context may be determined from a layer of structural context associated with entities. Context can be determined from auxiliary sensors, temporal state of the user or entity, personal context derived from related applications the user interacts with and/or preferences. These contextual signals may be semantically associated with entities. Depending on the type of contextual information associated with an entity, a set of potential recommendations associated with a given enrolled entity may be updated. This cohesive collection of entity, supporting context, and recommendation tags are used together to create an intelligent core memory identification system.

Once a user prescribes an entity, the system may relationally identify and enroll related entities. For example, if a user requests that the system remember their earbuds, the system will know to enroll portable audio playback devices a user interacts with. As such, if the user asks about an earbud case they saw previously that they might want to buy, the system has the ability to respond with precise information that relates to the user’s earbud.

Once an entity or event is processed and identified for storage, the memory ingestion engine 306 transmits the finalized data to the memory storage 318. Before persistent storage occurs, the system may perform filtering operations within the memory ingestion engine 306 to remove low-quality data, such as blurry images or frames that are substantially similar to previously captured data. This filtered information is then managed across the tiered architecture of the memory storage 318, which may include on-device memory, mobile device storage, and cloud-based memory. By utilizing the personalized context module 408 and the entity registry 410 to inform the ingestion process, the system achieves the technical effect of building a semantically linked memory bank that is optimized for both relevance and device efficiency. This architecture ensures that the stored data is not merely a collection of raw sensor captures but a contextually aware record that bridges the gap between the user's physical environment and digital memory retrieval.

FIG. 5 is a block diagram of some elements involved in memory retrieval in a memory augmentation system, according to an aspect. This system 500 facilitates the retrieval and surfacing of memories through both proactive and reactive mechanisms, utilizing real-time sensor data 304 alongside a structured repository of user context and entity information. As shown, the system 500 incorporates an ambient entity memory relevance engine 508, a user requested memory search engine 510, and a device and environment conditioning engine 512, all of which interact with a central hub comprising the personalized context module 514, a recommendations engine 516, and entity data 518. The personalized context module 514 may be similar to and may function in a similar manner as the personalized context module 408 of FIG. 4. The ambient entity memory relevance engine 508, a user requested memory search engine 510, and a device and environment conditioning engine 512 may function together to facilitate memory retrieval and to enable providing the memory output to user 520. In some implementations, these elements are part of a memory retrieval engine such as the memory retrieval engine 334 of FIG. 3.

Retrieval may occur in at least two ways, proactive retrieval and user query based retrieval. Proactive retrieval may occur when the memory retrieval system detects the relevance of any entity (or entities) and their associated recommendation tags to the user and determines to surface these entities (or their related recommendation tags) to the user without a specific user request. User based query may involve reacting to a user’s query for a previously stored entity and absorbing available ambient sensor data as well as various other ingestion data to provide relevant memory-driven information or actions to the user. Data from the personalized context module 514, recommendations engine 516 and/or entity data 518 may be provided to the ambient entity memory relevance engine 508 and/or the user requested memory search engine 510. The ambient entity memory relevance engine 508 and the user requested memory search engine 510 may identify temporal and/or user context for surfacing entities and/or memories. The ambient entity memory relevance engine 508 may also receive ambient sensor data 502 as an input.

The ambient entity memory relevance engine 508 is configured to facilitate proactive retrieval by identifying the relevance of entities or recommendation tags to the user without an explicit request. This engine receives ambient sensor data 502 as an input, which may include low-power signals from a visual sensor, an audio sensor, or an IMU. By processing these inputs in view of the personalized context module 514 and entity data 518, the ambient entity memory relevance engine 508 determines when to surface a proactive recommendation. For instance, if the system identifies a user is preparing to leave their home, it may proactively surface the location of their keys. The user requested memory search engine 510 facilitates reactive retrieval by processing a user query 504 and session history data 506. This engine performs ad hoc retrieval by calculating similarity metrics, such as cosine similarity, between the embeddings of the user query 504 and the stored memories to pinpoint relevant information.

The device and environment conditioning engine 512 receives processed data from the ambient entity memory relevance engine 508 and the user requested memory search engine 510 to tailor the output to the user. This engine determines the optimal presentation format such as visual, auditory, or action-oriented formats, based on the specific device type in use and/or the user’s current environment. For example, in an audio-heavy wearable device such as smart glasses with integrated speakers, the engine may provide concise verbal keywords or action steps. In a visual-heavy environment or device, the engine may condition the response to request user input via a display. To ensure battery efficiency during these operations, the system 500 may implement a tiered retrieval logic, where high-power processing or cloud-based data transfers are managed based on logistical factors such as connection strength and the current power state of the wearable device.

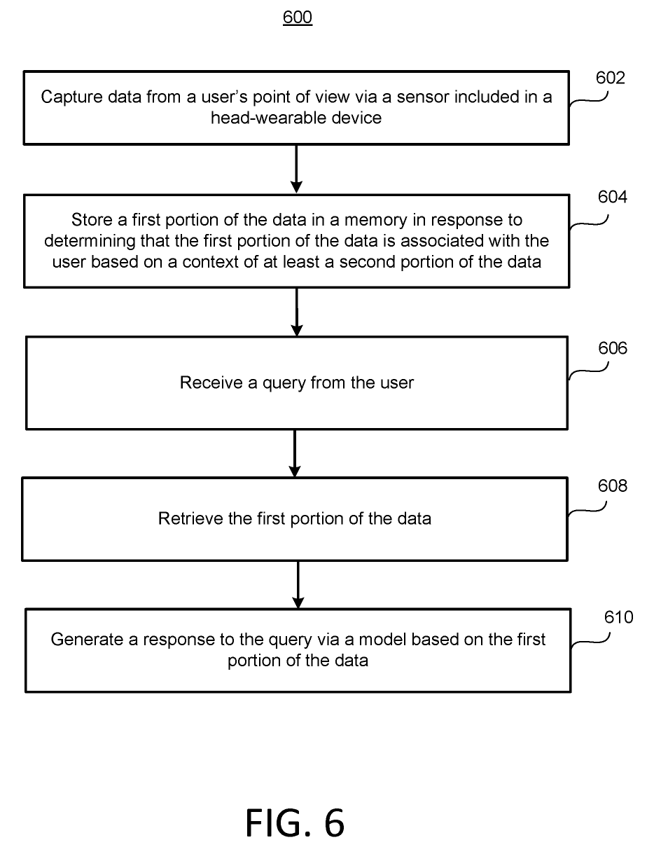

FIG. 6 is a flowchart depicting an example process for memory storage and retrieval, according to examples. Process 600 may be used to provide memory augmentation via a wearable device. In some implementations, process 600 may be performed by a computing device, such as the head-wearable devices of FIGS. 1A-1C and 2A-2C. Furthermore, process 600 may be performed by the memory augmentation system 300 of FIG. 3 or some of the elements of FIG. 4 or system 500 of FIG. 5. Although the process 600 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Process 600 begins with capturing data via a sensor included in a wearable device at step 602. The wearable device may be a device such as the head-wearable device 200 of FIGS. 2A-2C and/or the wearable device 104 of FIGS. 1A-1C. The sensor may be a camera, microphone, proximity sensor, capacitive sensor or IMU sensor. The sensor may be operating in a low power mode. After capturing the data, the process may proceed to determine that the captured data is relevant to the user. This may involve the use of a trigger condition recognition mechanism and/or examination of other contextual data and may involve the use of one or more models.

In response to determining that a first portion of the data is associated with the user based on a context of at least a second portion of the data, the first portion of the data may be stored in a memory, at step 604. The memory may be an on-device memory, a memory on a mobile device and/or a cloud-based memory. After storing the data, process 600 proceeds to receive a query from the user, at step 606. The query may be an explicit or implicit query received by a memory search module. In an example, the query is received during a conversation between the user and a conversational agent.

In response to receiving the query, process 600 proceeds to retrieve the first portion of the data, at step 608. This may involve examining the stored data and/or contextual data stored in a map associated with the data to determine if the stored first portion of the data is relevant to the query. Subsequent to retrieving the data, process 600 generates a response to the query via a model based on the data, at step 610.

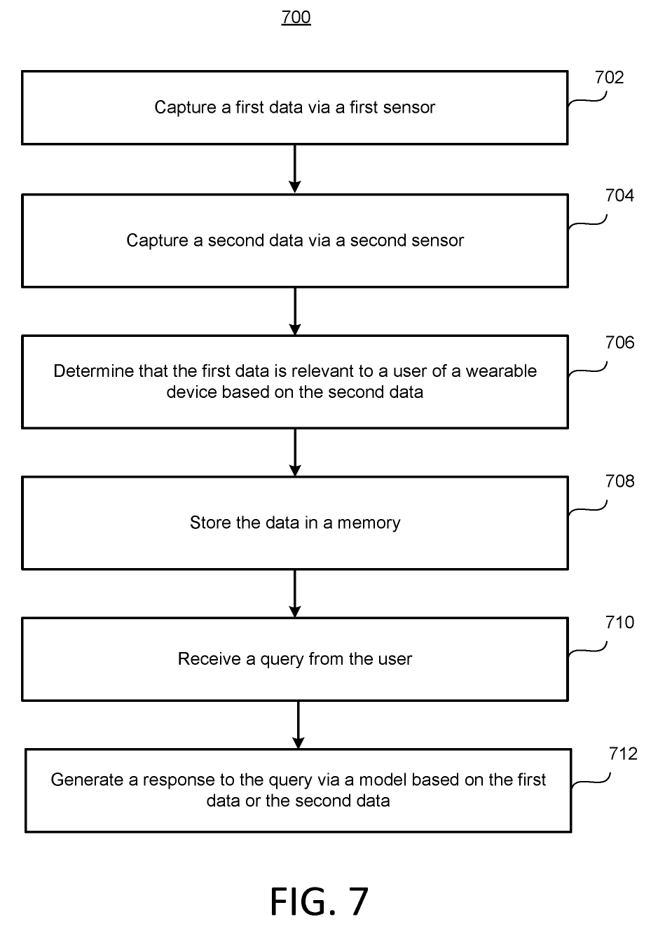

FIG. 7 is a flowchart depicting an alternative process for memory storage and retrieval, according to examples. Process 700 may be used to provide memory augmentation via a wearable device. In some implementations, process 700 may be performed by a computing device, such as the head-wearable devices of FIG. 1A-1C and FIGS. 2A-2C. Furthermore, process 700 may be performed by the memory augmentation system 300 of FIG. 3 or some of the elements of FIG. 4 or system 500 of FIG. 5. Although the process 700 illustrates the operations in sequential order, it will be appreciated that this is merely an example, and that additional or alternative operations may be included. Further, operations of FIG. 7 and related operations may be executed in a different order than that shown, or in a parallel or overlapping fashion.

Process 700 begins by capturing a first data via a first sensor, at step 702. The first sensor may include a visual sensor such as an RGB or NIR camera configured to capture environmental data from a user’s point of view. Simultaneously or sequentially, the process includes capturing a second data via a second sensor, at step 704. The second sensor may include an audio sensor, a location sensor, or an IMU. For example, the first data may comprise a series of image frames while the second data comprises an audio stream or inertial data.

At step 706, the process proceeds to determine that the first data is relevant to a user of a wearable device based on the second data. This determination may involve identifying a trigger condition or a trigger within the second data that provides context for the first data. For instance, the second data may include a verbal comment from the user such as "I am leaving my wallet here," which serves as a trigger to identify the wallet within the visual first data. Alternatively, the second data may include gaze tracking information indicating that the user’s focus has dwelled on a specific object in the first data for a duration exceeding a predetermined threshold. By using the second data as a contextual filter, the system can intelligently distinguish salient entities from mundane environmental data.

In response to determining relevance, the process proceeds to store the data in a memory at step 708. Storing the data may involve saving the first data, such as a high-resolution image of the identified object, alongside a map or metadata derived from the second data. The memory storage may utilize the tiered architecture described previously, involving an initial storage in an on-device memory followed by a batched transfer to a mobile device or cloud-based memory. This batching process may be managed based on logistical factors such as connection strength and the power state of the wearable device to achieve the technical effect of battery optimization.

Subsequent to storage, the process includes receiving a query from the user at step 710. The query may be an explicit request, such as a voice query submitted to a conversational agent, or an implicit request derived from the user’s ongoing activity. Finally, at step 712, the process generates a response to the query via a model based on the first data or the second data. For example, a visual language model may synthesize a response by processing the stored image (first data) in view of the temporal or spatial context provided by the second data. This ensures that the generated response is not only accurate regarding the identity of an object but also provides relevant details about the environment in which the memory was captured.

Further to the descriptions above, a user may be provided with controls allowing the user to make an election as to both if and when systems, programs or features described herein may enable collection of user information (e.g., information about a user’s environment, a user’s activities, or a user’s current location), and if the user is sent content or communications from a server. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium”, or “non-transitory computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship between client and server arises by virtue of computer programs running on the respective computers and having a client-server relationship with each other.

In this specification and the appended claims, the singular forms "a," "an" and "the" do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example computer-implemented methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

In one aspect, a non-transitory computer-readable medium stores instructions that, when executed by a processor on a receiving computing device, causes the receiving computing device to perform any of the methods disclosed herein.

In one aspect, a computing device can be configured with at least one processor and memory storing instructions that, when executed by the at least one processor, performs any of the methods disclosed herein.

The following paragraphs provide various examples of the embodiments disclosed herein.

In one aspect, a method is described that includes capturing data from a point of view of a user via a sensor included in a head-wearable device. The method further includes storing a first portion of the data in a memory in response to determining that the first portion of the data is associated with the user based on a context of at least a second portion of the data. A query is received from the user, and a response to the query is generated via a model based on the first portion of the data.

In another aspect, the data includes at least one of visual data, audio data, location data, or text data.

In another aspect, the sensor includes at least one of a camera, a microphone, or an inertial measurement unit.

In another aspect, the memory includes at least one of an on-device memory, a memory on a connected device, or a cloud-based memory.

In another aspect, the model is a visual language model.

In another aspect, the method further includes determining that the data is relevant to the user, wherein determining that the data is relevant to the user includes identifying a predetermined signal in the data.

In another aspect, the predetermined signal is provided by the user.

In another aspect, the predetermined signal is an object identified in visual data captured by the sensor or a word identified in audio data captured by the sensor.

In another aspect, storing the data includes storing contextual data associated with the user.

In another aspect, the method further includes determining that the data is relevant to the user, wherein determining that the data is relevant to the user is based on contextual data that is relevant to the user or the data.

In another aspect, the method further includes determining that the data is relevant to the user, wherein determining that the data is relevant to the user is based on identifying an entity that is relevant to the user in the data.

In another aspect, the sensor is operating in a low power mode of operation and the method further comprises detecting a trigger condition via the sensor while in the low power mode and triggering a capture of the data in response to the trigger condition.

In one aspect, a wearable device is described that includes a first sensor, a second sensor, a processor, and a memory storing instructions that, when executed by the processor, cause the wearable device to perform operations. The operations include capturing a first data via the first sensor and capturing a second data via the second sensor. The wearable device determines that the first data is relevant to a user of the wearable device based on the second data and stores the first data in the memory. Upon receiving a query from the user, the wearable device generates a response to the query via a model based on the first data or the second data.

In another aspect, storing the first data includes storing a map associated with the first data, where the map includes the second data.

In another aspect, the second data provides context that is relevant to the user.

In another aspect, the first data is retrieved based on the second data in response to receiving the query from the user.

In one aspect, a non-transitory computer-readable medium is described that stores instructions that, when executed by a processor on a computing device, causes the computing device to perform operations. The operations include capturing data from a point of view of a user via a sensor included in a computing device and determining that the data is relevant to the user. The data is stored in a memory in response to determining that the data is relevant to the user. Upon receiving a query from the user, the computing device generates a response to the query via a model based on the data.

In another aspect, storing the data in the memory includes storing the data in an on-device memory of the computing device and transferring the data from the on-device memory to a mobile device based on a connection state or a power state of the computing device.

In another aspect, the operations further include filtering the data prior to storing the data in the memory by removing a frame from the data based on a blurriness of the frame or a similarity between the frame and a previous frame.

In another aspect, the operations further include capturing audio data via an audio sensor included in the computing device and increasing a frame rate of a visual sensor included in the computing device in response to identifying a level of audio activity in the audio data that meets a criterion.

What is claimed is:

1. A method comprising:
capturing data from a point of view of a user via a sensor included in a head-wearable device;
storing a first portion of the data in a memory in response to determining that the first portion of the data is associated with the user based on a context of at least a second portion of the data;
receiving a query from the user; and
generating a response to the query via a model based on the first portion of the data.

2. The method of claim 1, further comprising determining that the data is relevant to the user, wherein determining that the data is relevant to the user includes identifying a predetermined signal in the data.

3. The method of claim 2, wherein the predetermined signal is provided by the user.

4. The method of claim 2, wherein the predetermined signal is an object identified in visual data captured by the sensor or a word identified in audio data captured by the sensor.

5. The method of claim 1, further comprising:
identifying a trigger condition within the captured data, the trigger condition including at least one of a level of audio activity meeting a criterion, a movement pattern meeting a threshold, or a recognition of a predetermined entity; and
increasing a sampling rate of the sensor in response to the identification of the trigger condition.

6. The method of claim 1, further comprising determining that the data is relevant to the user, wherein determining that the data is relevant to the user is based on contextual data that is relevant to the user or the data.

7. The method of claim 1, further comprising determining that the data is relevant to the user, wherein determining that the data is relevant to the user is based on identifying an entity that is relevant to the user in the data.

8. The method of claim 1, wherein the sensor is operating in a low power mode of operation, and the method further comprises:
detecting a trigger condition via the sensor while in the low power mode; and
triggering a capture of the data in response to the trigger condition.

9. The method of claim 1, further comprising:
executing a model locally on the head-wearable device to identify a sensitive portion of the data within a frame of the data, the sensitive portion including at least one of a face or a text string containing a password; and
applying a masking operation to the sensitive portion to obscure personally identifiable information before the data is transferred from the head-wearable device to a remote storage.

10. The method of claim 1, wherein storing the first portion of the data further comprises:
maintaining a memory architecture that is multi-tiered, the architecture including an on-device memory, a mobile device memory, and a cloud-based memory;
determining to transfer the data from the on-device memory to at least one of the mobile device memory or the cloud-based memory based on at least one of a current battery level of the head-wearable device, a memory buffer capacity, and a wireless connection strength; and
transferring the data in a batch from the on-device memory to the mobile device memory to reduce high-power transmission events.

11. The method of claim 1, further comprising:
associating the first portion of the data with a data structure in a registry, the data structure defining a relationship between at least two entities; and
automatically enrolling a new entity in the memory in response to identifying a new relationship between the new entity and an existing enrolled entity within the data structure.

12. The method of claim 1, wherein the memory includes at least one of an on-device memory, a memory on a connected device, or a cloud-based memory.

13. A wearable device comprising:
a first sensor;
a second sensor;
a processor; and
a memory storing instructions that, when executed by the processor, cause the wearable device to perform operations including:
capturing a first data via the first sensor;
capturing a second data via the second sensor;
determining that the first data is relevant to a user of the wearable device based on the second data;
storing the first data in the memory;
receiving a query from the user; and
generating a response to the query via a model based on the first data or the second data.

14. The wearable device of claim 13, wherein storing the first data includes storing a map associated with the first data, the map including the second data.

15. The wearable device of claim 13, wherein the second data provides context that is relevant to the user.

16. The wearable device of claim 13, wherein in response to receiving the query from the user, the first data is retrieved based on the second data.

17. A non-transitory computer-readable medium storing instructions that, when executed by a processor on a computing device, causes the computing device to perform operations comprising:
capturing data from a point of view of a user via a sensor included in a computing device;
determining that the data is relevant to the user;
storing the data in a memory in response to determining that the data is relevant to the user;
receiving a query from the user; and
generating a response to the query via a model based on the data.

18. The non-transitory computer-readable medium of claim 17, wherein storing the data in the memory comprises:
storing the data in an on-device memory of the computing device; and
transferring the data from the on-device memory to a mobile device in a batch transmission based on at least one of a connection state or a power state of the computing device.

19. The non-transitory computer-readable medium of claim 17, the operations further comprising filtering the data prior to storing the data in the memory by removing a frame from the data based on a blurriness of the frame or a similarity between the frame and a previous frame.

20. The non-transitory computer-readable medium of claim 17, the operations further comprising:
identifying a trigger condition within the captured data, the trigger condition including at least one of a level of audio activity meeting a criterion, a movement pattern meeting a threshold, or a recognition of a predetermined entity; and
increasing a sampling rate of a visual sensor included in the computing device in response to the identification of the trigger condition.

21. A method for retrieving memories in a memory augmentation system, the method comprising:
receiving a query via an agent of a head-wearable device;
accessing a set of persistent memories, the persistent memories comprising stored data identified as being relevant to a user;
identifying a stored memory as being relevant to the query by determining a similarity between the query and data stored in a memory;
retrieving the stored memory based on the similarity;
generating an input for the agent to receive an output from the agent, the input including at least one of the set of persistent memories, the stored memory, and a history of conversation with the agent; and
providing a response to the user via the agent based on the output.

22. The method of claim 21, wherein identifying the stored memory comprises:
determining a similarity value between an embedding of the query and a plurality of embeddings associated with a plurality of stored memories in the memory; and
selecting a first memory from the plurality of stored memories that meets a criterion to identify the stored memory.
